(19) United States
(12) Patent Application Publication
(10) Pub. No.: US 2012/0255334 A1
(43) Pub. Date: Oct. 11, 2012

(54) SOLUBLE ORGANIC FERTILIZER

(76) Inventor: Stephen Gans, Seffner, FL (US)

(21) Appl. No.: 13/441,482

(22) Filed: Apr. 6, 2012

Related U.S. Application Data
(60) Provisional application No. 61/473,640, filed on Apr. 8, 2011.

(51) Int. Cl. C05F 11/08; C05F 11/00

(52) U.S. Cl. 71/6; 71/11

(57) ABSTRACT

Soluble organic fertilizers and methods for preparing and using the same are disclosed. The soluble organic fertilizers of the invention contain soluble organic nutrients. Preparation of a soluble organic fertilizer of the invention involves extracting soluble organic nutrients from a solid organic nutrient source.

### CROSS REFERENCE TO RELATED APPLICATIONS

This application claims the benefit under 35 USC §119(e) of U.S. application Ser. No. 61/473,640 filed Apr. 8, 2011, which is incorporated by reference herein in its entirety.

### FIELD OF THE INVENTION

The present invention relates generally to organic fertilizers and specifically to soluble organic fertilizers.

### BACKGROUND OF THE INVENTION

Thirty years of research has been dedicated to various groups of microorganisms that have been investigated for their capacity to improve plant growth or reduce plant disease. Plant growth-promoting rhizobacteria (PGPR) are beneficial root-colonizing bacteria that elicit increased plant growth or reduced damage due to plant diseases. The plant growth promotion or biological disease control that results from inoculation of seeds or plant parts with beneficial microbes is due both to production of bacterial metabolites such as plant growth regulators and antibiotics that alter the plant or the native rhizosphere community. In addition, some PGPR alter the host plant's physiology in a way that induces resistance to diseases and stress.

Early applications of PGPR focused on their use as biological control agents more than growth promotion. Recently, with the growing global concern about reducing fertilizer run-off and contamination of surface and ground waters, there is a renewed interest in growth promotion. The goal is to select PGPR that increase root growth, thereby enabling the plant to increase uptake of applied fertilizers to allow reduced rates of fertilizers. This use of PGPR to increase nutrient uptake is termed integrated nutrient management and is a common current aim in many countries.

PGPR containing fertilizers, some of which are soluble, have been used successfully to increase plant growth and nutrition and control biological disease. For example, certain Pathway Biologics products have been shown to increase plant growth, reduce salt uptake of plants growing under conditions of salinity stress, reduce nematode load, protect against Fusarium wilt disease, and increase yield and nutrient uptake.

However, there is still a need for soluble organic fertilizers that may be applied by means other than granular applications, the spreading of manures, or the wind rowing and hauling of composted materials. Although solid and liquid organic fertilizers exist, both of those types of fertilizers have drawbacks. For example, with solid organic fertilizers, the nutrient sources in the fertilizer must be broken down by microorganisms before the nutrients can be used by plants, a process that takes time. Liquid organic fertilizers can be considered relatively unstable, due to their susceptibility to volatilization, oxidation, and decreased potency. Additionally, compared to a concentrated soluble material, liquid is much more costly to ship. Further, there is a need for a fertilizer than can be applied before and after a crop or plant is in advanced growth stages.

There is also a need for soluble forms of organic control of pathogens and other seasonal intrusions, allowing seasonal success free or substantially free from toxic chemicals

### SUMMARY OF THE INVENTION

In certain embodiments, a fertilizer containing at least one soluble organic nutrient is disclosed. The soluble organic nutrients may be macronutrients or micronutrients. In certain embodiments, the soluble organic nutrients include classified organic compounds selected from nitrogen, phosphorous, potassium, calcium, magnesium, sulfur, zinc, manganese, iron, molybdenum, copper, boron, and a vitamin. In certain embodiments, a soluble organic fertilizer further contains a beneficial microorganism.

In certain embodiments, a method of preparing a soluble organic fertilizer by extracting soluble organic nutrients from a solid organic nutrient source is disclosed. Extraction of a soluble organic nutrient may include liquefying a solid organic nutrient source, extracting soluble organic nutrients from the liquefied solid organic nutrient source, and saturating the soluble organic nutrients onto a soluble absorbent carrier.

In certain embodiments, liquefying a solid organic nutrient source is accomplished by incubating a solid organic nutrient source with at least one beneficial microorganism. The beneficial microorganisms may be from one or more of Bacillus, Clostridium, Rhodopseudomonas, Rhizobium, Azotobacter, Pseudomonas, Arthrobacter, Flavobacterium, Actinomycetes, Penicillium, Trichoderma, and Mycorrhizal.

In some aspects of the invention, extracting soluble organic nutrients from a liquefied solid organic nutrient source is accomplished by filtering the liquefied solid organic nutrient source.

In some aspects of the invention, soluble organic nutrients are saturated onto a soluble absorbent carrier by blending, spraying, and drying. The soluble absorbent carrier can be glucose, dextrose, sucrose, or fructose.

In some embodiments, a method of enhancing plant growth or crop production by applying a soluble organic fertilizer is disclosed. In certain embodiments, the soluble organic fertilizer is applied to a seed, soil, or a plant. In certain embodiments, the fertilizer is applied to a plant via foliar application. In certain embodiments, the fertilizer is applied to a seed, soil, or a plant by irrigation, drilling, broadcasting, or fogging.

### DETAILED DESCRIPTION OF THE INVENTION

The section headings used herein are for organizational purposes only and are not to be construed as limiting the subject matter described. The terminology used herein is for the purpose of describing particular embodiments only; it is not intended to be limiting. All references cited in this application are expressly incorporated by reference herein for any purpose.

The singular forms “a”, “an”, and “the” include plural references unless the context clearly dictates otherwise. Thus, for example, references to “the method” include one or more methods. Unless defined otherwise, all technical and scientific terms used herein have the same meaning as commonly understood by one of ordinary skill in the art.

The term “plant” includes both crop producing and non-crop producing plants, bushes, and trees. The term seed refers to a seed that will produce a plant whose growth or nutrition is promoted by a soluble organic fertilizer. The term soil refers to soil in which such a plant will be grown or is growing.

The term “fertilizer” means a material that is added to a soil or foliar fed to a plant to supply one or more plant nutrients. The materials may be of natural or synthetic origin. In certain embodiments, a fertilizer contains materials in addition to plant nutrients.

An organic fertilizer contains nutrients that can be classified organic.

A soluble fertilizer is capable of being dissolved. In certain embodiments, a soluble fertilizer is in a solid or gel form. In certain embodiments, a soluble fertilizer is capable of being dissolved in water and/or in liquid organic fertilizers.

A solid organic nutrient source refers to a material that contains an organic nutrient. Organic nutrient sources may be derived from animal parts, animal by-products, plant materials, and mined minerals. In certain embodiments, organic nutrients in the solid organic nutrient source are insoluble.

The term “liquefy” mean to break down. In certain embodiments, a solid organic nutrient source is liquefied. In certain embodiments, a solid organic nutrient source is liquefied microbiologically. A solid organic nutrient source may also be liquefied by other means known in the art.

A soluble organic nutrient is an organic nutrient that is capable of being dissolved. In certain embodiments, a soluble organic nutrient is capable of being dissolved in water and/or in liquid organic fertilizers.

A soluble organic fertilizer may contain any of the primary nutrients nitrogen (N), phosphorous (P), and potassium (K). The NPK value of a fertilizer is the ratio of nitrogen, phosphorus, and potassium in the fertilizer. A soluble organic fertilizer of the present invention may have any NPK value.

In addition to the primary nutrients nitrogen, phosphorus, and potassium, secondary nutrients may be present in a soluble organic fertilizer of the invention. Examples of secondary nutrients include calcium, magnesium, and sulfur. In certain embodiments, a soluble organic fertilizer may also contain micronutrient elements that can be classified organic. Examples include boron, manganese, zinc, copper, iron, molybdenum, and vitamins.

In some aspects of the invention, a soluble organic fertilizer contains soy proteins, amino acids, molasses, fermented molasses, calcium citrate, organic acids, kelp, fish emulsions, fish proteins, or organic humates.

In certain embodiments, a soluble organic fertilizer contains one or more beneficial microorganisms. The term microorganism includes a microbe and a microbial consortia. A beneficial microorganism is a microorganism that promotes plant health and/or augments nutrient availability when applied to a seed, soil, or a plant. In certain embodiments, a beneficial microorganism mineralizes organic nutrients in the fertilizer, causing the nutrients to be more readily plant available when the fertilizer is applied to a seed, soil, or a plant. In certain embodiments, a beneficial microorganism enhances the quality of the soil. A beneficial microorganism may also control one or more pathogens in or on a seed, in soil, or in or on a plant. Beneficial microorganisms include but are not limited to Bacillus, Clostridium, Rhodopseudomonas, Rhizobium, Azotobacter, Pseudomonas, Arthrobacter, Flavobacterium, Saccharomyces, Streptomyces, Penicillium, and Trichoderma. All the above microorganisms are readily available from public depositories including ATCC and NRRL.

In certain embodiments, beneficial microorganisms in a soluble organic fertilizer are present in from about 1×10² to 1×10¹⁵ colony forming units per gram or per milliliter. In certain embodiments, beneficial microorganisms are present in an amount sufficient to further enhance plant growth or nutrition when applied to a seed, soil, or a plant. In some aspects of the invention, beneficial microorganisms are present in an amount sufficient to control one or more pathogens in or on a seed, in the soil, or in or on a plant.

Optional components that can also be present in a fertilizer of the invention include natural enzymes, growth hormones, and organic control agents including pesticides, nematicides, fungicides, and insecticides.

Preparation of a soluble organic fertilizer involves extracting soluble organic nutrients from a solid organic nutrient source. A solid organic nutrient source typically contains primary and secondary nutrients.

Extraction of soluble organic nutrients from a solid organic nutrient source involves liquefying a solid organic nutrient source, extracting soluble organic nutrients from the liquefied source, and saturating the soluble organic nutrients onto a carrier.

In certain embodiments, a solid organic nutrient source is liquefied by pulverizing the source and then incubating the pulverized source with at least one beneficial microorganism. A beneficial microorganism may be from Bacillus, Clostridium, Rhodopseudomonas, Rhizobium, Azotobacter, Pseudomonas, Arthrobacter, Flavobacterium, Saccharomyces, Streptomyces, Penicillium, or Trichoderma.

Extracting soluble organic nutrients from a liquefied organic nutrient source involves removing insoluble material from the liquefied source. Insoluble materials, including residual organic materials that are fibrous in form, may be removed from a liquefied source by precipitation via pH adjustments, filtration, or other methods known in the art.

The soluble organic nutrient solution that remains after removal of insoluble materials from a liquefied organic nutrient source may be saturated into or onto a soluble absorbent carrier. In certain embodiments saturation is achieved by blending, spraying, and drying the soluble nutrient solution onto a soluble absorbent carrier. Exemplary soluble absorbent carriers include glucose, dextrose, sucrose, and fructose. In certain embodiments, drying is accomplished by low level heat.

In certain embodiments the soluble organic fertilizer is formulated to fulfill the particular requirements of the seed, soil, or plant to which the composition is applied. In certain embodiments the soluble organic fertilizer is formulated to enhance the growth or nutrition of a plant. In some embodiments the fertilizer is formulated to control one or more pathogens in or on a seed, in the soil, or in or on a plant.

The quantity of a soluble organic fertilizer applied to a seed, soil, or a plant may be an amount effective to enhance the growth or nutrition of the plant. In some embodiments the quantity of fertilizer applied is an amount effective to control one or more pathogens in or on a seed, in the soil, or in or on a plant.

The invention of the present application further encompasses methods of enhancing plant growth and/or crop production comprising applying a soluble organic fertilizer to a seed, soil, or a plant. The fertilizer may be applied to a plant via foliar application. In some embodiments the fertilizer may be applied to a seed, soil, or a plant via irrigation, drilling, broadcasting, or fogging. In some embodiments the fertilizer may be applied to a seed, soil, or a plant during one or more of the various stages of growth of a plant.

### EXAMPLE: PREPARATION OF A SOLUBLE ORGANIC FERTILIZER

A solid organic source of primary and secondary nutrients was liquefied. Solid organic sources of primary and secondary nutrients included, but were not limited to, bone meal, feather meal, corn gluten, soy protein, fish, and kelp. The solid organic nutrient source was liquefied by first pulverizing the organic nutrient source through designed grinders, thus breaking down the source into very fine particulates. The fine particulates were then inoculated with a single genus or a combination of genera of beneficial microorganisms from Bacillus, Clostridium, Rhodopseudomonas, Rhizobium, Azotobacter, Pseudomonas, Arthrobacter, Flavobacterium, Actinomycetes, Penicillium, Trichoderma, and Mycorrhizal. The solution containing the pulverized particulates and microbial inoculant was incubated for about fifteen days. The solution was then filtered. The filtrate was then blended, sprayed, and dried by low level heat onto at least one of the soluble absorbent carriers glucose, dextrose, sucrose, and fructose.

Although the invention has been described with reference to the above example, it will be understood that modifications and variations are encompassed within the spirit and scope of the invention. Accordingly, the invention is limited only by the following claims.

What is claimed is:

1. A soluble organic fertilizer comprising at least one soluble organic nutrient.

2. The fertilizer of claim 1, wherein the at least one soluble organic nutrient is selected from the group consisting of organic macronutrients and organic micronutrients.

3. The fertilizer of claim 2, wherein the organic macronutrients and macronutrients are classified organic compounds selected from the group consisting of nitrogen, phosphorous, potassium, calcium, magnesium, sulfur, zinc, manganese, iron, molybdenum, copper, boron, and a vitamin.

4. The fertilizer of claim 1, further comprising at least one beneficial microorganism.

5. A method of preparing a soluble organic fertilizer comprising:
a) liquefying a solid organic nutrient source;
b) extracting at least one soluble organic nutrient from the liquefied solid organic nutrient source; and
b) saturating the at least one soluble organic nutrient onto a soluble absorbent carrier.

6. The method of claim 5, wherein liquefying a solid organic nutrient source comprises incubating a solid organic nutrient source with at least one beneficial microorganism.

7. The method of claim 6, wherein the beneficial microorganism is selected from the group consisting of Bacillus, Clostridium, Rhodopseudomonas, Rhizobium, Azotobacter, Pseudomonas, Arthrobacter, Flavobacterium, Actinomycetes, Penicillium, Trichoderma, and Mycorrhizal.

8. The method of claim 5, wherein extracting the soluble organic nutrient from the liquefied solid organic nutrient source comprises filtering the liquefied source.

9. The method of claim 5, wherein saturating the soluble organic nutrient onto a soluble absorbent carrier comprises blending, spraying, and drying the nutrient onto the carrier.

10. The method of claim 5, wherein the soluble absorbent carrier is selected from the group consisting of glucose, dextrose, sucrose, and fructose.

11. A method of enhancing plant growth or nutrition or crop production comprising applying a soluble organic fertilizer of claim 1 to a seed, soil, or a plant.

12. The method of claim 11, wherein the fertilizer is applied to a plant via foliar application.

13. The method of claim 11, wherein the fertilizer is applied by means of a method selected from the group consisting of irrigation, drilling, broadcasting, and fogging.
